(19) United States
(12) Patent Application Publication
(10) Pub. No.: US 2005/0041765 A1
(43) Pub. Date: Feb. 24, 2005

(54) Synchronization of data-processing units

(76) Inventors: Lambros Dalakuras, Leonberg (DE); Andreas Boehm, Kornwestheim (DE)

Correspondence Address: KENYON & KENYON, ONE BROADWAY, NEW YORK, NY, 10004, US

(21) Appl. No.: 10/898,302

(22) Filed: Jul. 23, 2004

(30) Foreign Application Priority Data
Jul. 25, 2003 (DE) 103 33 934.5

(51) Int. Cl. H04L 7/00

(52) U.S. Cl. 375/356

(57) ABSTRACT

A master unit and at least one slave unit, each having a time signal transmitter for providing a time signal whose value is representative for a time elapsed since a zero point in time, are connected via a bus and are synchronized. The synchronization is by: a) transmitting a synchronizing signal defining an instant on the bus; storing the value of the time signal provided by the time signal transmitter of at least each slave unit at the instant defined by the synchronizing signal; c) transmitting the value that the time signal of the master unit has at the instant defined by the synchronizing signal; d)ascertaining, in each slave unit, a time differential corresponding to the difference between the time signal value stored in b) and the time signal value transmitted in c), and correcting the time signal transmitter of the slave unit according to the ascertained time differential.

### FIELD OF THE INVENTION

The present invention relates to a method for synchronizing a plurality of data-processing units in a network, as well as a network in which the method may be used.

### BACKGROUND INFORMATION

The progressive electronification of control tasks in automotive technology has had the result that electrical and electronic units such as sensors, actuators and control units are utilized in ever growing numbers in today's motor vehicles to carry out the most diverse tasks. As the number of units grows, so does the expenditure for their wiring. In order to limit the wiring measures and the costs associated therewith, it has proven expedient that each individual sensor or each individual actuating element is no longer connected via individual signal lines to a control unit that processes the sensing signals of the sensor or that supplies actuating signals for the actuating element, but rather that a plurality of such sensors or actuating elements be connected, in each case via a suitable interface circuit, to a common bus on which signals in the form of addressed messages can be transmitted between the control unit and the various interfaces in time division multiplex.

Although the use of a bus may substantially reduce the wiring expenditure, this advantage bears the cost that the temporal coordination of various sensors and/or actuators is made more difficult. In a bus-supported network, in order to coordinate temporally coordinated actions of various connected data processing units (which may in particular be understood as the combination of a sensor or actuator with its assigned interface circuit), a command which specifies the action and the time of its execution must be sent to these units prior to the beginning of the action that is to be executed, since, as a result of the time division multiplex operation, it cannot be ensured that the bus will be available at the desired time of the action to send commands for immediate execution of the desired action to the desired data-processing units. However, if a command specifying the time of an action is sent to the data-processing units ahead of time, it is imperative for the temporal coordination of the actions to be executed that the units have a common time standard.

One alternative for establishing such a common time standard for all data-processing units is the use of a clock signal, which is transmitted on the bus and whose periods are counted by the connected units as well. However, this approach may be unsatisfactory insofar as it requires its own signal line or a large portion of the transmission bandwidth of an individual bus line, and to the extent that counting errors, which may occur in the individual data-processing units due to transmission interference on the bus, may be prevented only by costly additional measures.

Another alternative is to provide each data-processing unit with its own time signal transmitter. However, unavoidable scattering of the operating frequencies of these time signal transmitters may cause an initial synchronicity to be lost over the course of time, so that here, too, an exact temporal coordination of the actions to be executed by the individual units cannot be guaranteed without further measures.

### SUMMARY OF THE INVENTION

An exemplary embodiment and/or exemplary method of the present invention provides a network of data-processing units and a method for synchronizing a plurality of data-processing units in a network, which allows an exact synchronization of the units in an uncomplicated manner and without great demands on the transmission capacity of a bus connecting the units.

Of the various units connected to the bus, the one whose time sets the standard for the other units is designated as the master unit, and the ones that are meant to adjust their time to the time of the master unit are designated as slave units.

The synchronization between master and slave units is based on the transmission of a synchronizing signal on a bus, this signal defining an instant in time; storing of the value of the time signal provided by a time signal transmitter of at least each slave unit at the instant defined by the synchronizing signal; transmission of the value which the time signal of the master unit has at the instant defined by the synchronizing signal; and detection, in each slave unit, of a time differential which corresponds to the difference between the stored and the transmitted time signal value; and correction of the time signal transmitter of each slave unit in accordance with the time differential ascertained in this manner.

The instant at which the time signal value of the master unit is transmitted to the slave units is of no consequence for the accuracy of the synchronization.

In an advantageous manner, the time transmitters may be digital counters which are periodically incremented or decremented with the aid of a clock signal, and the time signal values are in each case count values of these counters. The difference of the time signal values then is a direct measure for the time differential between the time transmitters of master and slave unit, and a correction may occur by simple addition of this difference to an instantaneous count value of the time transmitter of the slave unit.

The clock signal on which the time signal transmitter is based, is best generated in each unit by a local clock generator of this unit.

The synchronizing signal could basically come from any source; for instance, it could be manually triggered by a user. The synchronizing signal may be automatically generated by the master unit.

In a bus on which various types of messages are transmitted—one type of message being a command to synchronize the time signal transmitter of at least one of the slave units—a pattern that it identically transmitted in each synchronization command and which is able to be recognized by the slave unit, may advantageously be utilized as synchronizing signal.

For the sake of simplicity, a pattern which is included in each message transmitted on the bus, regardless of the type, may be utilized as synchronizing signal. For instance, an introductory sequence, which in each case marks the beginning of a message transmitted on the bus, may be used as synchronizing signal. This may be useful in particular when messages are transmitted on the bus in an asynchronous manner, without being tied to a specified time pattern.

To simplify the processing in the slave units, it may be useful if the synchronizing signal and the value of the time signal of the master unit by which the slave units are to be synchronized are each transmitted in an identical message.

### BRIEF DESCRIPTION OF THE DRAWINGS

FIG. 1 shows a schematic block diagram of a network in which an exemplary embodiment and/or exemplary method of the present invention is able to be used.

FIG. 2 shows a block diagram of a master unit of the network.

FIG. 3 shows a block diagram of a slave unit.

FIG. 4 shows a flow chart of a working process executed by master and slave units.

### DETAILED DESCRIPTION

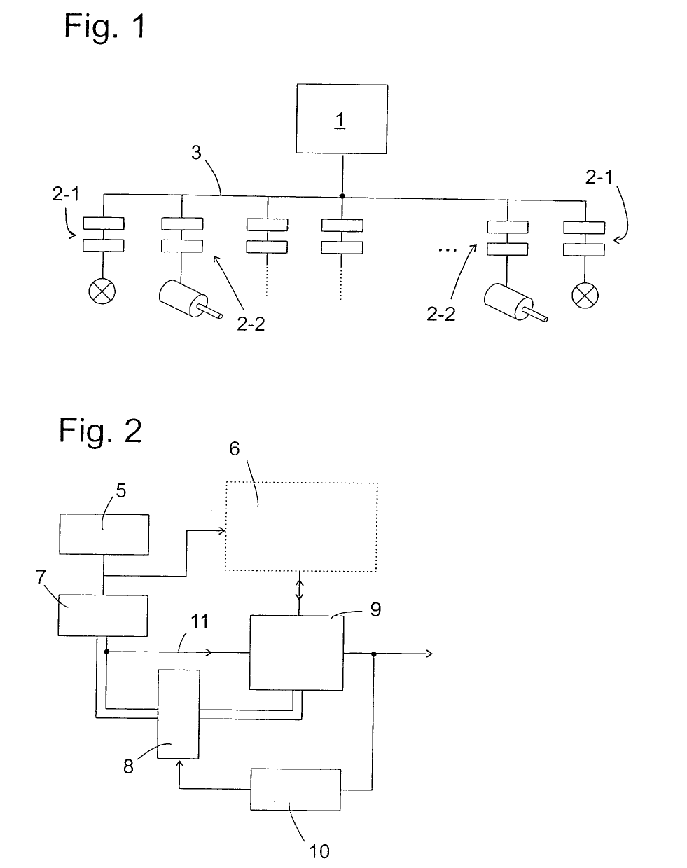

FIG. 1 is a block diagram of a data-processing network having a master unit 1 and a plurality of slave units 2-1, 2-2, . . . , altogether also referred to as slave units 2, which are connected via a LIN-bus 3. On a LIN (local interconnect network) bus, only master unit 1 is entitled to send messages on the bus; upwards transmission of data from slave units 2 to master unit 1 in each case take place only upon request of the master unit. A detailed description of the LIN standard will not be given here since it is not required to understand an exemplary embodiment and/or exemplary method of the present invention. Reference may be made to the available LIN Standard. The LIN standard may be found on the Internet (see “www.carbussystems.com/lin.html”).

The slave units denoted by 2-1 are each made up of an interface for the bus communication and a control circuit for an indicator light. Slave units 2-2 control a windshield-wiper motor, for instance, and further slave units may be provided to control the locks of a central locking system, etc. To coordinate the turn-on and turn-off of the indicators or the motion of the windshield wipers, master unit 1 transmits to the respective slave units 2 commands that specify the action to be triggered and the time of triggering. Furthermore, synchronization commands for the adaptation of local time signal transmitters of slave units 2 are transmitted on the bus to a time signal transmitter of master unit 1.

FIG. 2 schematically shows the configuration of master unit 1. A clock signal having a frequency f₁ is supplied by a clock pulse generator 5 to a control processor 6, which, in a program-controlled manner, carries out various control tasks on the basis of external commands and data received via bus 3, which are not the subject matter of an exemplary embodiment and/or exemplary method of the present invention and receive no further treatment here. The clock signal of clock pulse generator 5 also controls a time signal transmitter 7 in the form of a digital counter whose counter content is incremented (or decremented) with each period of the clock signal. A register 8 is connected by its data input to a parallel output of the time signal transmitter. A message generator 9 is connected via a line 11 to a carry bit output or a high-value bit of the count-value output of time signal transmitter 7. On the one hand, message generator 9 is used to convert commands, transmitted by control processor 6 and destined for one or a plurality of slave units 2, into a messages that are compatible with the format required for LIN bus 3 and to transmit them on LIN bus 3. On the other hand, it is used to transmit synchronization commands to slave units 2 in a triggered manner, via the signal it receives from time signal transmitter 7.

Such a synchronization message includes a header with a leader that is uniform for all messages transmitted on bus 3. It also includes type information, which identifies the message as synchronization command, and address information, which identifies slave units 2 for which the message is intended. In a synchronization message, these are generally all slave units 2 connected to LIN bus 3.

Connected to the transmit output, leading to the bus, of message generator 9 is a pattern-recognition circuit 10, which monitors the data traffic on bus 3 for the occurrence of the leader, which is uniform for each message and, upon detection of such a leader, transmits a trigger pulse to register 8, thereby inducing it to store the count value provided at the instantaneous time by time signal transmitter 7. A data output of register 8 is connected to an input of message generator 9, which allows it to read the content of register 8 after the uniform leader of a synchronization message has been output and while the type and address information is sent, and to insert it as data value into the synchronization message just generated.

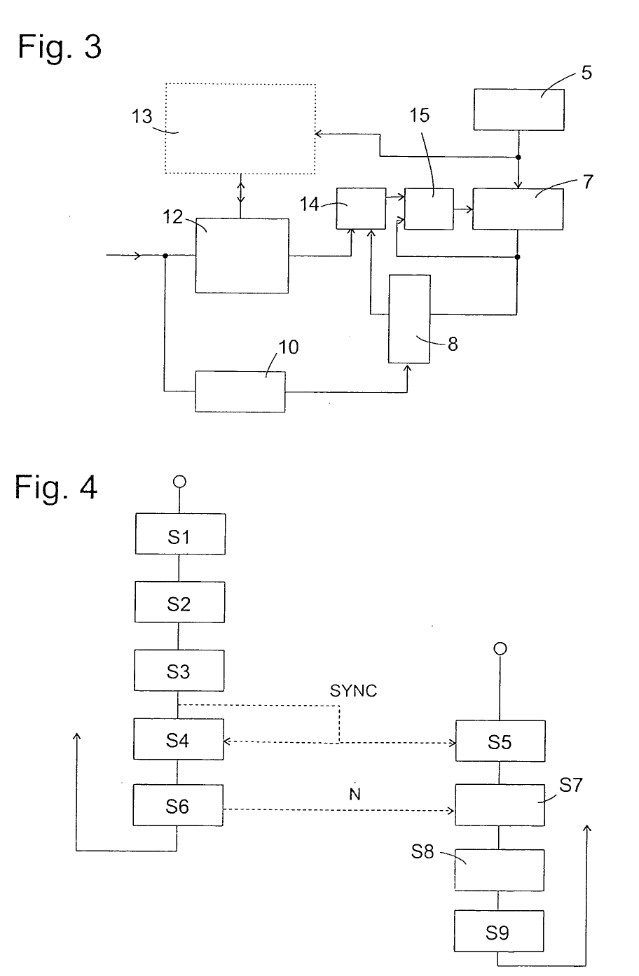

FIG. 3 schematically shows the configuration of a slave unit 2. A message decoder connected to LIN bus 3 is used to detect the individual messages transmitted on the bus, to extract the type and address information from the header so as to analyze, using the address information, whether a given message is meant for slave unit 2 and, if applicable, to relay the type information and the data possibly included in the message to a control circuit 13, which executes the activity requested by master unit 1 in the message. Synchronization messages are not processed by control circuit 13 but by other components of slave unit 2 in the manner described in the following.

When message decoder 12 detects a synchronization message, it forwards the counter content of time signal transmitter 7, which is included therein in the form of data, to a first input of a differential circuit 14.

As in the case of master unit 1, slave unit 2 has a local clock generator 5, although its clock-pulse period f₂ may deviate slightly from clock-pulse period f1 of the master unit; it also includes a time signal transmitter 7, which is incremented (or decremented) by the clock signal from clock generator 5; and a register 8 of which one data input is connected to a parallel count-value output of time signal transmitter 7.

Connected to LIN bus 3 is a pattern-recognition circuit 10, which, too, may have the same configuration as that used for master unit 1 and which, when detecting the pattern that is uniform for all messages on the bus, controls register 8, so that it adopts the count value present at its data input at this instant and transmits it at its output. This output is connected to a second input of differential circuit 14. As soon as message decoder 12 detects that the currently received message is indeed a synchronization message, it triggers differential circuit 14, so that it forms the difference between the count values available at its two inputs and outputs it to a first input of a summing network 15. A second input of this summing network 15 is connected to the data output of time signal transmitter 7, which at this time is already able to output a different count value than at the time of activation of register 8 by pattern-recognition circuit 10. Summing network 15 outputs the sum of the values available at its two inputs. The count value of time signal transmitter 7 is overwritten with the output of summation network 15, thereby making it identical to the count value of time signal transmitter 7 of the master unit at the same instant.

The time sequence of the synchronization method is illustrated in FIG. 4 with the aid of a flow chart. The blocks in the left part of the diagram denote processing steps of master unit 1 and those in the right part of the diagram denote processing steps of slave unit 2. In step S1, there is a wait for the occurrence of a synchronization instant. A synchronization instant may be determined, for instance, by a level change of a high-value bit of time signal transmitter 7 of master unit 1 when this bit is switched through to message generator 9 via line 11, or it may be the instant of a counter overflow if line 11 is connected to a carry output of time signal transmitter 7.

In step S2, message generator 9 is triggered, via line 11, to generate a synchronization message. Message generator 9 is not necessarily able to comply with such a request immediately. If higher-priority requests for transmitting messages from control processor 6 are present simultaneously, the synchronization message is postponed until these requests have been processed. This has no influence on the accuracy of the synchronization because the counter content of time signal transmitter 7 of master unit 1 will be adopted into its register 8 only when the message generator begins transmitting the synchronization message on the bus in step S3 (symbolized by a dashed arrow SYNC) and pattern-recognition circuit 10 of master unit 1 detects the leader of this message in step S4.

At the same time, in step S5, the leader of the synchronization message is detected at slave units 2 as well, so that the adoption of the count values of time signal transmitter 7 into registers 8 in master and slave units 1, 2 is implemented simultaneously. In step S6, the count value of master unit 1 is transmitted to the slave units (symbolized by a dashed arrow N), which in step S7 deduct their own count values from this count value and, in step S8, add the result, at a possibly later instant with a changed counter content, to their instantaneous counter content and, in step S9, overwrite the instantaneous counter reading with the result obtained in the process. The method subsequently returns to the beginning in master and slave units.

1. A method for synchronizing a plurality of data-processing units, among which are a master unit and at least one slave unit, which each have a time signal transmitter for providing a time signal whose value is representative for a time that has elapsed since a zero point in time and which are connected via a bus, the method including:
(a) transmitting on the bus a synchronizing signal that defines an instant;
(b) storing the value of the time signal provided by the time signal transmitter of at least each slave unit at the instant defined by the synchronizing signal;
(c) transmitting the value that the time signal of the master unit has at the instant defined by the synchronizing signal; and
(d) ascertaining, in each slave unit, a time differential that corresponds to a difference between the time signal value stored in (b) and the time signal value transmitted in (c), and correcting the time signal transmitter of the slave unit according to the ascertained time differential.

2. The method of claim 1, wherein the time signal generators include digital counters, which are periodically incremented or decremented with a clock signal, and the time signal values in each case are count values of the digital counters.

3. The method of claim 2, wherein in (d) the difference between the count value transmitted in (c) and the count value stored in (b) is formed and is added to the count value stored in (b).

4. The method of claim 2, wherein the clock signal in each unit is generated by a local clock-pulse generator of this unit.

5. The method of claim 1, wherein the synchronizing signal is generated by the master unit.

6. The method of claim 5, wherein different types of messages are transmitted on the bus, one type of message being a command for synchronizing the time signal transmitter of at least one of the slave units, and the synchronizing signal being a pattern that is identically transmitted in each command for synchronizing.

7. The method of claim 6, wherein the pattern is transmitted in each message transmitted on the bus.

8. The method of claim 7, wherein the synchronizing signal includes a beginning sequence that is identical for all messages.

9. The method of claim 8, wherein the synchronizing signal and a value of the time signal of the master unit are transmitted in an identical message at the instant defined by the synchronizing signal.

10. The method of claim 6, wherein the synchronizing signal and a value of the time signal of the master unit are transmitted in an identical message at the instant defined by the synchronizing signal.

11. The method of claim 7, wherein the synchronizing signal and a value of the time signal of the master unit are transmitted in an identical message at the instant defined by the synchronizing signal.

12. A network comprising:
a plurality of data-processing units, which include:
a master unit,
at least one slave unit,
wherein each includes a time signal transmitter for providing a time signal whose value is representative for a time that has elapsed since a zero point in time and which are connected via a bus;
wherein the master unit includes:
a transmitting device for transmitting a synchronizing signal defining an instant, for performing the following:
(a) transmitting on the bus a synchronizing signal that defines an instant,
(b) storing the value of the time signal provided by the time signal transmitter of at least each slave unit at the instant defined by the synchronizing signal,
(c) transmitting the value that the time signal of the master unit has at the instant defined by the synchronizing signal, and
(d) ascertaining, in each slave unit, a time differential that corresponds to a difference between the time signal value stored in (b) and the time signal value transmitted in (c), and correcting the time signal transmitter of the slave unit according to the ascertained time differential;
a recording device for recording the value of its time signal at the instant defined by the synchronizing signal, and
an inserting a device for inserting this value into a message transmitted on the bus;
wherein each slave unit includes:
storing devices for storing the value of its time signal at the instant defined by the synchronization instant, for determining the time differential representing a difference between the value received from the master unit and a stored value of the time signal, and for adapting its own time signal transmitter based on the time differential.

13. The network of claim 12, wherein the bus includes a LIN bus.

14. The network of claim 13, wherein the network is installed in a motor vehicle.

15. The network of claim 12, wherein the network is installed in a motor vehicle.
